(19) United States
(12) Patent Application Publication
(10) Pub. No.: US 2022/0055783 A1
(43) Pub. Date: Feb. 24, 2022

(54) Freeze Pop Package Clipper and A Method to Open Freeze Pop Packaging

(71) Applicant: Sharon Anita WARRINGTON, Teaneck, NJ (US)

(72) Inventor: Sharon Anita WARRINGTON, Teaneck, NJ (US)

(21) Appl. No.: 17/407,501

(22) Filed: Aug. 20, 2021

Related U.S. Application Data
(60) Provisional application No. 63/068,164, filed on Aug. 20, 2020.

(51) Int. Cl. B65B 69/00; B26D 5/10; B26D 7/26; B26D 1/00; B26D 5/08

(52) U.S. Cl. CPC B65B 69/0033; B26D 5/10; B26D 2007/0018; B26D 1/0006; B26D 5/086; B26D 7/2628

(57) ABSTRACT

A hand-held cutting device configured to safely, easily, and reliably remove the plastic tip of the plastic packaging of a Freeze Pop is disclosed. The device includes a housing with a slot into which the tip of the unopened Freeze Pop is inserted. Inside the slot is an internal cutting mechanism which produces a curved cut to remove the tip of the Freeze Pop. The tip then falls into a collection chamber which may be opened for easy disposal of plastic scraps. The entire device is storable on a magnetic surface via a removable magnetic component.

### PRIORITY

This application claims priority of the U.S. provisional application No. 63/068,164 filed on Aug. 20, 2020, the contents of which is incorporated herein by reference.

### BACKGROUND OF THE INVENTION

The objective of this invention is to provide a means for safely, easily, and reliably removing the plastic tip of the plastic packaging of so called “Freeze Pops,” frozen treats which come in a clear plastic tube. Consumers have experienced various inconveniences when attempting to open the packaging or remove its plastic tip. For example, certain consumers opt to remove the plastic tip by using their teeth to rip the plastic at the end. However, this option is not available nor desirable by everyone, especially not those who require assistance in opening the plastic packaging or those concerned with hygiene.

Other consumers opt to remove the plastic tip by using scissors or other instruments with exposed blades. In the event of mishandling, especially by young children, the exposed blades of scissors or other instruments present an unnecessary danger to the user and anyone else within the vicinity. Furthermore, scissors or other instruments may not always be readily available or safe to carry around without a dedicated cover or sleeve. Thus, a safer, easier, and more reliable means to remove the plastic tip on Freeze Pops is desired.

### SUMMARY OF THE INVENTION

The invention disclosed herein is a hand-held cutting device configured to safely, easily, and reliably remove the plastic tip of the plastic packaging of a Freeze Pop or any other tubular plastic or paper packaging of an alimentary product. The device comprises a housing preferably made of plastic, but other materials may also be used. The housing may also be cosmetically designed to have various shapes, such as animal figures, cars, etc. The housing has a slot into which the tip of the unopened Freeze Pop is inserted. Inside the slot is an internal cutting mechanism, which may be a plurality of sets of blades from which a set of blades may be selected to perform the cutting operation. The selection of the set of blades can be accomplished via a lever or multiple levers fitted to the housing. The cutting mechanism configured in this way may be referred to as either a “selectable cutting mechanism” or simply as “selectable.” Alternatively, the internal cutting mechanism may be a blade with an adjustable cutting edge.

Each of the internal cutting mechanisms disclosed herein comprise at least one non-rusting blade which produces a curved cut. The blade may be made of stainless steel, another metal, or a different material altogether. It is to be understood that all possible cutting mechanisms of the device are “internal,” meaning that the blade or cutting surface is never exposed to the environment, and therefore will never come into contact with the user's skin. The housing of the device is what encloses the cutting mechanism, thereby making it “internal.”

The adjustment to the adjustable cutting edge involves increasing or decreasing the size of the arc of the resulting cut and is carried out via one or more levers fitted to the housing. The cutting mechanism configured in this way may be referred to as either an “adjustable cutting mechanism” or simply as “adjustable.”

A Freeze Pop cut by a blade which can only cut linearly will necessarily result in at least one sharp corner being formed on the plastic packaging. These corners become apparent when the tube is pressed flat, often inside a consumer's mouth. The resulting sharp corner may jab at the inside of the consumer's mouth and potentially cut the skin. The cutting mechanism of this device produces a curved cut, which is advantageous since it does not allow for the formation of sharp corners.

In one embodiment, the device may be entirely mechanical, wherein the cutting mechanism is driven by a lever fitted to the housing. Any lever fitted to the housing, regardless of its purpose in the device, also comprises a handle which may have an ergonomic grip. The ergonomic grip is any special shape that the handle may have or any addition to the handle that makes it easier to grasp. In another embodiment, the device may be powered electronically, preferably by batteries, wherein the cutting mechanism activates upon the press of a button or the flip of a switch on the housing.

In another embodiment, the device may also comprise a collection chamber to collect the cut plastic scraps resulting from the cutting operation. The collection chamber is contained within the device and is preferably not removable, but it is openable. The collection chamber may have an indented side, a button, or a tab, any of which can be pressed to open the chamber. The collection chamber may also be opened by other means. Alternatively, the collection chamber may be removable and disposable. Opening the collection chamber grants access to the contents within and allows for cleaning of the device and disposal of the plastic scraps. The collection chamber preferably also has one or more vents to allow for air to pass through, which aids in the prevention or reduction of growth of microbes.

In another embodiment, the device further comprises a removable magnetic storage component which is attachable to the housing. The magnetic storage component must be secured to the housing by means other than a magnet. An example of such means is snapping or sliding the container underneath a lip or into a groove in bottom of the housing. Using the magnetic storage component, the entire device may be stored on a magnetic surface such as a refrigerator door.

In another embodiment, the entire device, except for the magnetic storage component, is made of plastic. This embodiment includes a plastic cutting mechanism.

In another embodiment, any plastic that the device contains may contain one or more additives to prevent the growth of microbes. Alternatively, any plastic of the device may be made of antimicrobial materials.

In another embodiment, the device is dishwasher safe, meaning the device must not only be waterproof, but it also must not be damaged from hot or cold streams of water normally encountered in modern household dishwashers.

Other embodiments of this device may selectively incorporate the features listed above alone or in combination.

### SHORT DESCRIPTION OF THE FIGURES

FIG. 1 shows a schematic drawing of an embodiment of the Freeze Pop Package Clipper where the internal cutting mechanism is adjustable. The figure shows the housing (1), an adjustable cutting mechanism (2), cutting blade (3), cutting mechanism operation lever (4), operation lever handle (4a), cutting mechanism adjustment lever (5), cutting mechanism adjustment lever handle (5a), collection chamber (6), collection chamber opening (7), magnetic storage component (8), a slot or insertion opening (9), an opening to the collection chamber (10). An unopened Freeze Pop (20) is inserted via an insertion opening (6).

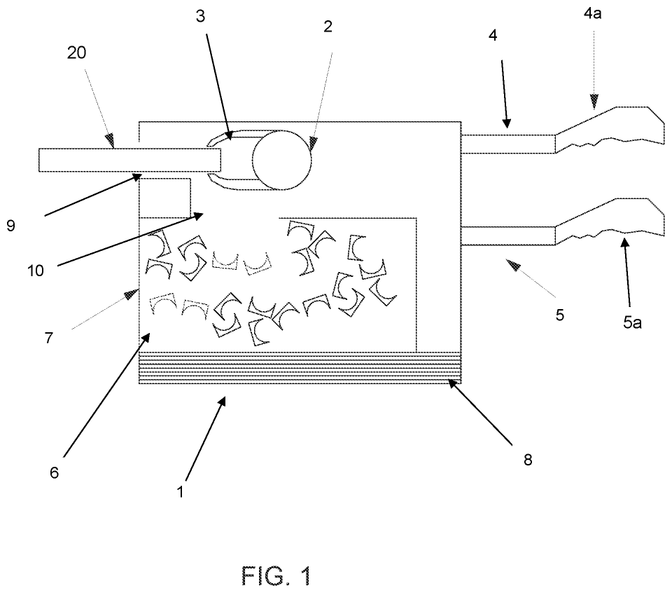

FIG. 2 shows a schematic drawing of another embodiment of the Freeze Pop Package Clipper where the internal cutting mechanism is selectable. The figure shows the housing (1), a selectable cutting mechanism (2a), cutting blade (3), plurality of sets of blades (3b), cutting mechanism operation lever (4), operation lever handle (4a), cutting mechanism adjustment lever (5), cutting mechanism adjustment lever handle (5a), collection chamber (6), collection chamber opening (7), magnetic storage component (8), a slot or insertion opening (9), an opening to the collection chamber (10). An unopened Freeze Pop (20) is inserted via an insertion opening (6).

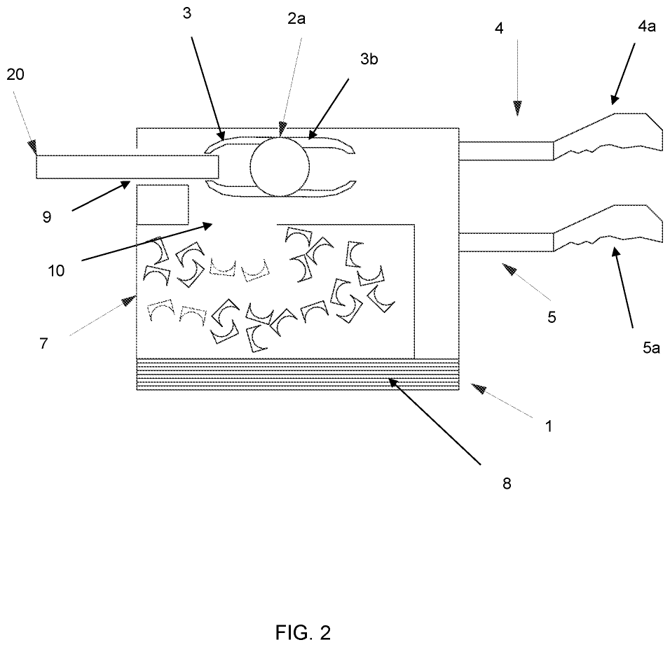

FIG. 3 shows a side-by-side comparison of a linear cutting result with sharp corner (12) and the Freeze Pop Package Clipper's curved cut (14).

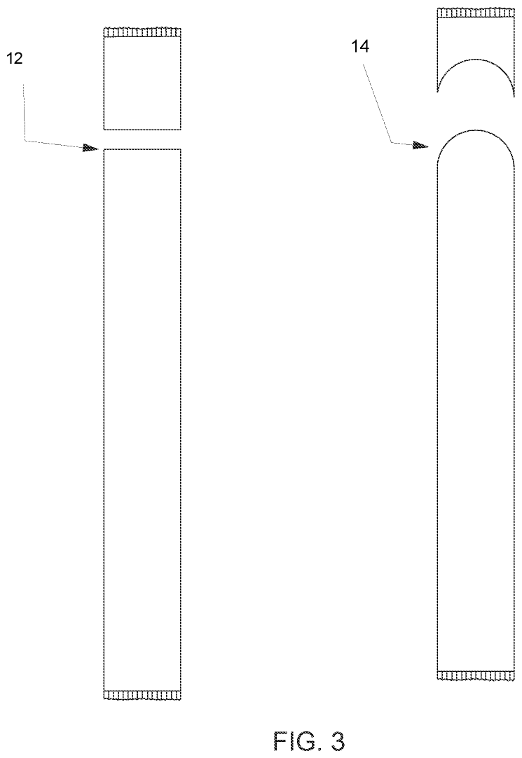

### DESCRIPTION OF THE INVENTION

One preferred embodiment of this invention comprises the plastic housing (1) made of antimicrobial materials, the adjustable cutting mechanism (2), the non-removable collection chamber (6) having a collection chamber opening (7), the removable magnetic storage component (8), wherein the device is also dishwasher safe and entirely mechanical. The collection chamber opening (7) may be openable for example by squeezing the housing. Alternatively, the collection chamber may have an intended wall which may be pressed to open the collection chamber opening.

Operation of the device, as embodied by the description above, is as follows:

A user retrieves the device, possibly from a magnetic surface used for storage purposes. Depending on the Freeze Pop size, the user moves a lever (5) configured to adjust the size of the arc to be cut to ensure a proper sized cut. According to certain embodiment the device has a plurality of sets of blades (3b) from which a set of blades may be selected to perform the cutting operation.

The user then inserts one end of a Freeze Pop into the insertion opening or slot (9) of the housing and pulls down a lever (4) configured to operate the cutting mechanism. The tip of the plastic packaging of the Freeze Pop, which may also include some of the Freeze Pop itself, is removed by the cutting mechanism and falls into the collection chamber (6) through an opening (10) on top of the collection chamber below the cutting mechanism. The user may continue to cut open multiple other Freeze Pops without emptying the collection chamber. When finished with the device, the user may then open the collection chamber opening by pressing on the indented side of the collection chamber or squeezing the housing. The collection chamber can easily be emptied once opened. Since the device is dishwasher safe, the user may insert it into a dishwasher for cleaning, but the device can alternatively be cleaned by rinsing the insides with water. The cleaned device should then be dried and reattached to the magnetic storage component so that the entire device may be stored.

### ELEMENT LISTING

1 Housing
2 Adjustable cutting mechanism
2a Selectable cutting mechanism
3 Blade
3b Set of selectable blades
4 Cutting mechanism lever
4a Cutting mechanism lever handle
5 Adjustment mechanism lever
5a Adjustment mechanism lever handle
6 Collection chamber
7 Collection chamber opening
8 Magnetic component
9 Insertion opening or slot
10 Opening to the collection chamber
12 Sharp cut
14 Curved cut
20 Unopened Freeze Pop

What is claimed is:

1. A hand-held cutting device for removing a tip of a tubular plastic packaging of an alimentary product, which device comprises:
a housing comprising a slot into which the tubular plastic packaging is inserted;
an internal cutting mechanism comprising at least one blade;
at least one lever comprising a handle;
wherein the housing encloses the cutting mechanism such that no blade is exposed to the environment or a user's skin.

2. The device according to claim 1, wherein the internal cutting mechanism is a selectable cutting mechanism comprising a plurality of sets of blades from which a set of blades to be used in a cutting operation is selected, wherein any set of blades of the plurality of sets of blades comprises at least one non-rusting blade that produces a curved cut.

3. The device according to claim 1, wherein the internal cutting mechanism is an adjustable cutting mechanism comprising at least one non-rusting blade that produces a curved cut, wherein a size of an arc of the curved cut is adjustable via one of the at least one levers.

4. The device according to claim 1, wherein the device further comprises an openable collection chamber comprising at least one air vent, wherein the openable collection chamber comprises means to allow for opening the openable collection chamber.

5. The device according to claim 4, wherein the means to allow for opening the openable collection chamber comprises a pressable button, a pressable tab, or a pressable indented side.

6. The device according to claim 1 wherein the handle of the at least one lever comprises an ergonomic grip.

7. The device according to claim 1, wherein the devices further comprises a removable magnetic storage component.

8. The device according to claim 1, wherein the device, except for the magnetic storage component, is entirely made of plastic.

9. The device according to claim 1, wherein the housing is made of plastic.

10. The device according to claim 1, wherein the device is dishwasher safe.

11. The device according to claim 1, wherein the device is mechanically powered.

12. The device according to claim 1, wherein the device is electronically powered.

13. The device according to claim 1, wherein any plastic of the device comprises at least one additive to inhibit the growth of microbes.

14. The device according to claim 1, wherein any plastic of the device is made of antimicrobial materials.

15. A method to open a tubular plastic packaging containing an alimentary product, which method comprises the steps of:
retrieving the device according to claim 1, optionally detaching the device from the removable magnetic storage component;
selecting or adjusting the cutting mechanism to ensure a proper cut;
inserting an end of an unopened packaging into the slot;
pulling a lever configured to operate the cutting mechanism;
collecting scraps of plastic removed by the cutting mechanism in the collection chamber.

16. The method of claim 15, wherein the tubular plastic packaging is a Freeze Pop packaging.
